(19) United States
(12) Patent Application Publication
(10) Pub. No.: US 2010/0302518 A1
(43) Pub. Date: Dec. 2, 2010

(54) LITHOGRAPHIC APPARATUS

(75) Inventors: Jan VAN EIJK, Eindhoven (NL); Sjoerd Nicolaas Lambertus DONDERS, Vught (NL); Johannes Henricus Wilhelmus JACOBS, Heeze (NL); Nicolaas TEN KATE, Almkerk (NL); Johannes Petrus Martinus Bernardus VERMEULEN, Helmond (NL); Koen Jacobus Johannes Maria ZAAL, Eindhoven (NL); Marinus Jan REMIE, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/768,902

(22) Filed: Apr. 28, 2010

Related U.S. Application Data
(60) Provisional application No. 61/181,148, filed on May 26, 2009.

(51) Int. Cl. G03B 27/52

(52) U.S. Cl. 355/30

(57) ABSTRACT

The invention relates to a lithographic apparatus arranged to transfer a pattern from a patterning device onto a substrate, including a cooling system to cool a part of the lithographic apparatus, the cooling system including a droplet ejector to form droplets and fire the droplets towards a cooling surface of the part of the lithographic apparatus to cool the part by evaporation of the droplets.

### CROSS REFERENCE TO RELATED APPLICATIONS

This application claims priority and benefit under 35 U.S.C. §119(e) to U.S. Provisional Patent Application No. 61/181,148, entitled “Lithographic Apparatus”, filed on May 26, 2009. The content of that application is incorporated herein in its entirety by reference.

### FIELD

The present invention relates to a lithographic apparatus arranged to transfer a pattern from a patterning device onto a substrate.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Usually, a lithographic apparatus includes multiple heat sources. Examples of such heat sources are actuators used to apply forces to moveable or floating objects, e.g. contactlessly suspended stationary objects, and the radiation beam which may be absorbed by parts of the lithographic apparatus, e.g. optical parts such as the patterning device or lenses of an illumination system.

The heat sources, such as actuators, result in varying temperatures and temperature gradients which may negatively influence the accuracy of the lithographic apparatus and thereby the pattern transfer from patterning device to substrate. Another example of a negative influence is when the patterning device includes an opaque material to block at least a part of a radiation beam and thereby impart a pattern to the radiation beam. Blocking the radiation beam means that at least a part of the radiation beam is absorbed by the opaque material, resulting in a temperature increase of this particular portion of the patterning device. As the opaque material is not homogeneous applied to the patterning device and/or the radiation beam is not incident to the entire patterning device, the temperature distribution inside the patterning device is also not homogeneous. This results in a deformation of the patterning device and thus a deformed pattern will be transferred to the substrate. The lithographic apparatus therefore usually includes cooling systems to cool parts of the lithographic apparatus and thereby increase the accuracy of the lithographic apparatus.

Current cooling systems usually require substantive contact between the cooling system and the part to be cooled, e.g. the actuators. For example, it may be necessary to attach the cooling system to a moveable object, thereby increasing the weight of the moveable object, and/or hoses filled with running cooling agent may be connected to the moveable or floating object, thereby introducing force disturbances to the moveable object. When the part to be cooled is an optical element, local contact between the cooling system and the optical element may block a part of the optical path which is undesired, so that contact may only be made temporarily during use, or contact is made further away from the optical element resulting in undesired high temperature gradients to cool the optical element.

### SUMMARY

It is desirable to provide a lithographic apparatus with an improved cooling system.

According to an embodiment of the invention, there is provided a lithographic apparatus arranged to transfer a pattern from a patterning device onto a substrate, including a cooling system to cool a part of the lithographic apparatus, the cooling system including a droplet formation and firing device to form droplets and fire the droplets towards a cooling surface of the part of the lithographic apparatus to cool the part by evaporation of the droplets.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a portion of a lithographic apparatus according to another embodiment of the invention;

FIG. 3 depicts a portion of a lithographic apparatus according to yet another embodiment of the invention;

FIG. 4 depicts a portion of a lithographic apparatus according to a further embodiment of the invention;

FIG. 5 depicts a portion of a lithographic apparatus according to another embodiment of the invention.

### DETAILED DESCRIPTION

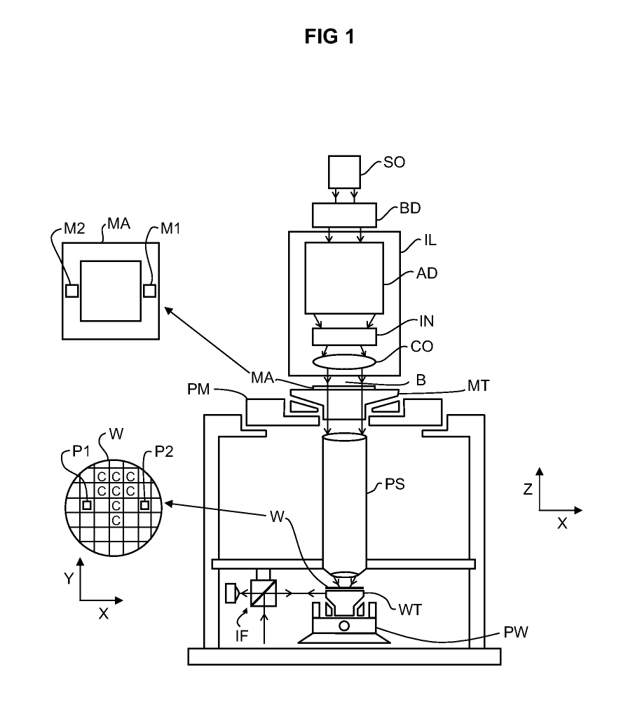

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the patterning device support (e.g. mask table) MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Depending on the specific configuration of the lithographic apparatus, the lithographic apparatus includes one or more heat sources, such as actuators or a radiation beam. These heat sources influence the temperature of different parts of the lithographic apparatus because of direct contact, i.e. conduction, but also due to heat radiation or convection. The lithographic apparatus therefore includes cooling systems to cool parts of the lithographic apparatus thereby increasing the accuracy of the lithographic apparatus.

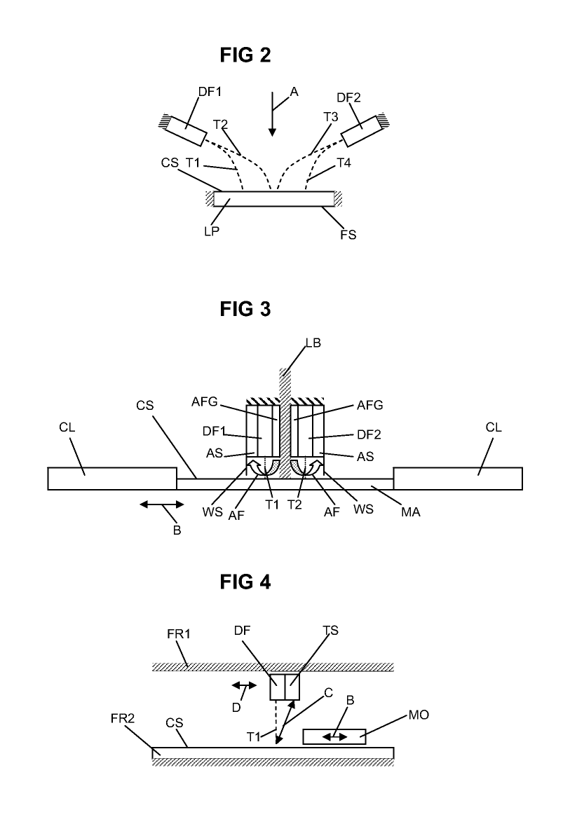

The cooling systems are not explicitly shown in FIG. 1, but examples of cooling systems which may be used in a lithographic apparatus according to the invention are shown in FIGS. 2 to 5 and will be described below.

FIG. 2 shows a portion of a lithographic apparatus according to an embodiment of the invention, for instance the lithographic apparatus according to FIG. 1. FIG. 2 shows a part LP, which in this embodiment is an optical element, such as a patterning device or a lens of an illumination system. The direction of light or radiation beam incident to the part LP, i.e. the optical path is indicated by arrow A. The part LP is depicted as a stationary part of the lithographic apparatus, although relatively small movements may be allowed, and also includes a floating part which is kept stationary by actuators to dynamically uncouple the part from other parts of the lithographic apparatus.

The lithographic apparatus further includes a cooling system to cool the part LP of the lithographic apparatus. The cooling system in this embodiment includes two droplet formation and firing devices DF1, DF2. The droplet formation and firing device can be broadly termed hereinafter a “droplet ejector”. However, an embodiment with only one droplet formation and firing device or more than two is also conceivable. The droplet formation and firing devices DF1, DF2 are configured to form droplets and fire the droplets towards a cooling surface CS of the part LP of the lithographic apparatus. The fired droplets will land on the cooling surface CS and evaporate, thereby extracting heat from the part LP and accordingly cool the part LP.

The droplet formation and firing device or droplet ejector may be constructed like an inkjet device and usually includes a chamber connected to a nozzle and a reservoir. Droplets are fired from the chamber through the nozzle by an actuation element after which the chamber is filled again with liquid from the reservoir. Various actuation principles can be used including thermal actuation in which a current pulse runs through a heating element to cause a steam explosion in the chamber to form a bubble inside the chamber which propels a droplet of liquid from the chamber through the nozzle, and piezoelectric actuation in which a piezoelectric material generates a pressure pulse in the chamber due to a shape and/or size change induced by an applied voltage. The generated pressure pulse propels a droplet of liquid from the chamber through the nozzle. Other actuation principles such as acoustic actuation, electrostatic actuation, etc. can also be used, but are less widely used in inkjet devices.

The droplet formation and firing device or droplet ejector may also be constructed like an electrospray device and then usually includes a capillary through which a liquid is supplied. By supplying a high voltage to the supplied liquid ideally a taylor cone is formed, which emits a liquid jet through its apex. Varicose waves on the surface of the jet then lead to the formation of small liquid droplets

The cooling system may further include an air condition controlling device (controller) (not shown) to control the condition of the air in an environment of the part LP. The air condition controlling device in its simplest form is a mere passive connection to the environment allowing humidified air to be replaced by dry air. If such a connection would be absent, continuous evaporation of the droplets would saturate the air above the cooling surface. The air condition controller may alternatively or additionally also include valves, air flow devices, e.g. ventilators, or air dehumidifying devices controlling the humidity of the air above the cooling surface. It may be well possible to use liquid extracted from the air by the air dehumidifying device as a source for the droplet formation and firing device, thereby forming a closed loop system of liquid.

The benefit of the cooling system according to the invention is that the contact between the cooling system and the part to be cooled is minimal. As the part to be cooled is not a moveable part, the cooling system may be connected to the part, but there is only mere local contact between the cooling surface CS and the cooling system when cooling is required and droplets are placed on the cooling surface. The cooling system is thus not blocking the optical path, or if the droplets block the optical path, this is kept to a minimum.

Two possible trajectories T1, T2, respectively T3, T4 per droplet formation and firing device DF1, DF2 are shown, which the fired droplets may follow from the droplet formation and firing device towards the cooling surface CS. In this embodiment, the trajectory is determined by a firing velocity of the droplet when the droplet leaves the droplet formation and firing device, but it is also possible that the droplet formation and firing device rotates to change the trajectory of the fired droplets. The different possible trajectories enables a droplet formation and firing device to place a droplet on different locations on the cooling surface CS, so that the entire cooling surface can be cooled if necessary. The droplet formation and firing device may be a drop-on-demand device which is able to form one droplet at a time, as is known from inkjet devices. This increases the controllability of the placement of droplets with respect to a spray of droplets. The usage of more droplet formation and firing devices is beneficial if more cooling capacity is required. Alternatively, the droplet formation and firing device may form multiple droplets at a time as in electrospray devices.

From cooling point of view it is preferred to cool as close to a site where heat is generated as possible. In case of a patterning device including an opaque material to block the radiation beam, it is preferred to cool the opaque material, so that heat does not get a chance to spread through the patterning device. However, it may be impractical to cool the opaque material, for instance because the opaque material is shielded by a so-called pellicle. Alternatively, the patterning device may be cooled on another side of the patterning device opposite the opaque material.

Another benefit of cooling the patterning device at another location then the pattern, i.e. the opaque material is that the pattern is located in a focal surface FS, and droplets fired towards the focal surface will also be in focus thereby distorting the image the most. By designing the cooling surface CS to be out of focus, a light beam is focused on focal surface FS and not on cooling surface CS, and the light beam distortion due to the potential droplets or drying stains placed on the cooling surface CS is minimal.

To further minimize the distortion of the light beam, the droplets formed by the droplet formation and firing devices are preferably as small as possible, for instance having a diameter between 0.1 and 100 micrometer. Due to the small size, the influence of the droplets is small, but also the evaporation is much faster, so that the time interval the influence exist is also smaller.

Preferably, the droplets include water, preferably ultra pure water to minimize residuals such as drying stains but also other liquids and fluidized gases such as carbon dioxide, ethane, butane, propane, propylene, ammonia, acetone, ethanol and isopropanol may also be possible. The benefit of water is that it has a relatively high specific heat capacity so that the cooling effect per droplet is maximal. The droplets may also include a surfactant, such as an alcohol, to lower the surface tension of the droplets. The lower fluid surface tension of the fluid, the droplet will spread out more then in case of a higher fluid surface tension, giving a larger surface area. Due to the larger surface area, the evaporation will be faster.

A benefit of the cooling system is that there is no direct contact required between the cooling system and the cooling surface thereby allowing to use the optical element while being cooled as the cooling system is substantially not obstructing the optical path. The cooling system may be connected to a frame (not shown) to which also the part LP is connected.

FIG. 3 shows a portion of a lithographic apparatus according to another embodiment of the invention. The portion includes a patterning device MA which may be part of a lithographic apparatus according to FIG. 1. The patterning device MA is clamped between two clamps CL which are moveable as indicated by arrow B. The patterning device MA in this embodiment is in particular suitable for a scan mode type of lithographic apparatus, wherein the patterning device MA is only partially exposed to a stationary light beam LB and a pattern on the patterning device is “scanned” through the light beam LB. Depending on the scanning direction, i.e. to the left or right, cooling of the patterning device is required on respectively the left or right side of the light beam LB. The lithographic apparatus therefore includes a cooling system with a droplet formation and firing device DF1, DF2 on either side of the light beam LB.

The droplet formation and firing devices DF1 and DF2 are configured to form droplets and fire them towards a cooling surface CS of the patterning device MA along respective trajectories T1, T2. The fired droplets will land on the cooling surface CS and evaporate there, thereby cooling the patterning device MA. By moving the patterning device in the direction indicated by arrow B, the entire cooling surface can be cooled by a droplet formation and firing device.

The benefit is that the contact between the patterning device and the cooling system is kept to a minimum. The patterning device thus does not have to carry parts of the cooling system thereby increasing the moveable mass of the patterning device, and no hoses need to be connected to the patterning device thereby introducing force disturbances. The cooling system is also not blocking the optical path represented by light beam LB. Only local contact between the droplets and the cooling surface is required when cooling is required and only for the time interval it takes for the droplet to evaporate.

The cooling system further includes an air condition controlling device to control a condition of air in the environment of the patterning device. The air condition controlling device includes an air flow generator, i.e. air flow device, AFG and an air suction device AS per droplet formation and firing device DF1, DF2. The air flow generator AFG is configured to generate an air flow AF and direct it along the cooling surface at the location where the droplets are fired. The air flow may be provided with a low humidity of the air causing a higher concentration gradient between the amount of vaporized water in the air on the one hand and on the cooling surface on the other hand. This enhances the evaporation of the droplets as the air flow can take the by the evaporation moisturized air away and supplies new drier air to the cooling surface. It may further be beneficial to increase the flow rate of the air flow causing a thinner boundary layer and a higher refreshment rate, both effects also resulting in a higher evaporation rate. The air suction device takes the moisturized air flow from the cooling surface, so that the air is not able to go to other portions of the lithographic apparatus. This may also be beneficial if the other portions of the lithographic apparatus are operated in vacuum. In addition, wall sections WS can be provided around the cooling system to substantially close off an area above the cooling surface CS of the patterning device MA, thereby further preventing moisturized air to flow away and contaminate other portions of the lithographic apparatus. The cooling system is arranged to operate inside the area.

The air condition controlling device may also include an air dehumidifying device to extract liquid from the air, so that air can be circulated by the air flow generator and air suction device.

In FIG. 3, the cooling system is shown to be stationary with respect to the light beam LB. When no wall sections WS are provided, this suffices, but when wall sections WS are provided, the clamps CL are not able to pass the cooling system which may be undesired. In that case, the cooling system may be moveable in a vertical direction to allow the passage of the clamps CL in horizontal direction. This may also be beneficial in case the clamps are obstructed by the droplet and firing devices or air flow generators themselves. Alternatively, the cooling system may also be moveable in the direction indicated by arrow B so that the cooling system remains between the clamps and moves with the patterning device.

It is possible that the air suction device includes an air humidity sensor to measure the humidity of the air downstream of the cooling surface CS. The output of the humidity sensor can be used to control the corresponding droplet formation and firing device and/or the corresponding air flow generator.

In another example the air suction device may also be provided with a controller and an air flow sensor to create a control system to control the corresponding droplet formation and firing device and/or the corresponding air flow generator to realize for example a certain fixed temperature of the cooling surface CS or to realize a specified cooling capacity based on the actually desired cooling requirements, which may for example relate to a setpoint of a movable part in the lithographic apparatus.

The air flow generator and air suction device may also be used to minimize aberrations in the optical path of the light beam to improve the pattern transfer from patterning device to a substrate (not shown).

In this embodiment, the cooling system is not directly in contact with the patterning device. The cooling system may be connected to a frame part. The patterning device and clamps are moveable with respect to a frame part, which may be the same as to which the cooling system is connected to.

FIG. 4 shows a portion of a lithographic apparatus according to another embodiment of the invention. The lithographic apparatus includes an object MO which is moveable with respect to a frame FR2 as indicated by arrow B. In this embodiment, the moveable object MO is moved with respect to frame FR2 by a linear electromagnetic actuator, wherein permanent magnets are located in the moveable object MO and coils are located in the frame part FR2. As the coils are current carrying elements, they heat up when operated. This means that when the object MO is moving, the frame part behind the object MO is increased in temperature. This increased temperature may negatively effect other parts of the lithographic apparatus due to radiation, conduction or convection. The lithographic apparatus therefore includes a cooling system to cool the frame FR2 if necessary.

The cooling system includes a droplet formation and firing device DF to form droplets and fire them towards a cooling surface CS of the frame part FR2. To be able to cool the entire cooling surface, the droplet formation and firing device is moveable with respect to a frame FR1, as indicated by arrow D. Preferably, a position control system is provided to control the position of the droplet formation and firing device DF with respect to the moveable object MO. More preferably, the position control system is able to move the droplet formation and firing device with the same speed and acceleration as the moveable object MO, so that the droplet formation and firing device is able to follow the moveable object MO.

A benefit of the cooling system of this embodiment is that the size of the cooling system is small compared to the cooling surface. The result is a compact cooling system. Another benefit may be that the cooling system may also be configured to cool the moveable object itself without needing significant modifications. Further, if an optical path, i.e. radiation beam, is moveable with respect to moveable object MO, the moveability of the cooling system allows to adapt itself to the moving optical path, thereby preventing the blockage of a part of the optical path by the cooling system and be able to cool as close to the optical path as possible.

The cooling system includes a temperature sensor TS to locally measure a temperature of the cooling surface CS, as indicated by the arrow Cw, and a control system or controller (not shown) to control the droplet formation and firing device in dependency of an output of the temperature sensor. Preferably, the control system is configured to place a droplet on a point on the cooling surface having an increased temperature as measured by the temperature sensor TS. In case the cooling system includes an air flow generator as shown in FIG. 3, the control system may further be configured to control the air flow generator based on the output of the temperature sensor TS.

The frames FR1 and FR2 may be connected to each other.

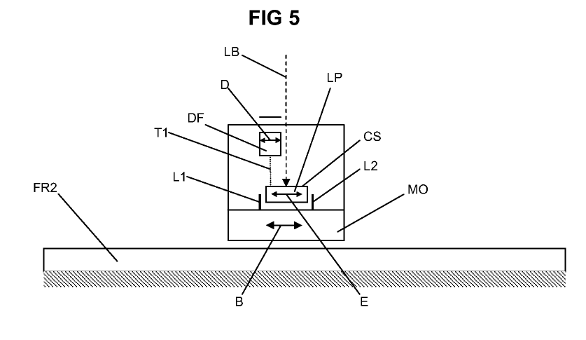

FIG. 5 shows a portion of a lithographic apparatus according to another embodiment of the invention. The lithographic apparatus including a part LP, which may be a substrate table or support, or a patterning device support. As is indicated by arrow E, the part LP is moveable with respect to a moveable object MO, which in turn is moveable with respect to a frame FR2, as indicated by arrow B.

The part LP is positioned with respect to a light beam LB. Movement of the part LP is realized with the aid of a long-stroke module (coarse positioning) between the moveable object MO and the frame FR2, and a short-stroke module (fine positioning) between the moveable object MO and the part LP. The limited range of the short-stroke module is schematically represented by limiters L1, L2 which form the boundaries of the limited range between the limiters.

Arranged on the moveable object is a cooling system with a droplet formation and firing device DF, which is moveable with respect to the moveable object MO, as is indicated by arrow D, and thus also moveable with respect to the part LP. The droplet formation and firing device DF is configured to form droplets and fire them towards a cooling surface CS on the part LP along trajectory T1, but in another embodiment the droplet formation and firing device DF may also be configured to form droplets and provide or fire them towards a cooling surface, which forms a part of the MO (long-stroke module).

As a further example, an embodiment of the invention may be used to cool the actuator from the moveable object MO or the part LP directly. A droplet formation and firing device DF may be mounted on the movable object MO (long-stroke module) or fixed world. As the motor moves, the mover may be cooled according to an embodiment of the invention. It may be further beneficial to increase the surface of the actuator by using fins and/or ripples to increase the effective evaporation area and to increase the cooling capacity of the system accordingly. The fins and/or ripples furthermore cause the air flow to become (more) turbulent which decreases the boundary layer and which effect also increases the evaporation rate.

A benefit of the cooling system is that no direct contact is required between the cooling system and the part LP to be cooled. The moveability of the cooling system also allows to cool on both sides of the light beam LB with a single droplet formation and firing device.

It is noted that different features and aspects of the shown embodiments may readily be combined and are not limited to a particular embodiment.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A lithographic apparatus arranged to transfer a pattern from a patterning device onto a substrate, the apparatus comprising a cooling system to cool a part of the lithographic apparatus, the cooling system including a droplet ejector configured to form droplets and fire the droplets towards a cooling surface of the part of the lithographic apparatus to cool the part by evaporation of the droplets.

2. The lithographic apparatus according to claim 1, wherein the cooling system comprises an air condition controller configured to control a condition of air in an environment of the part of the lithographic apparatus.

3. The lithographic apparatus according to claim 1, wherein the droplet ejector is configured to fire the droplets towards a cooling surface of a moveable part of the lithographic apparatus.

4. The lithographic apparatus according to claim 1, wherein the droplet ejector is configured to fire the droplets towards a cooling surface of an optical element of the lithographic apparatus, and wherein the cooling surface is designed to be out of focus.

5. The lithographic apparatus according to claim 1, wherein the droplets comprise a suitable liquid such as water.

6. The lithographic apparatus according to claim 1, wherein the droplets comprise a suitable fluidized gas such as carbon dioxide.

7. The lithographic apparatus according to claim 1, wherein the droplets comprise a surfactant to lower the surface tension of the droplets.

8. The lithographic apparatus according to claim 1, wherein the droplet ejector is a drop-on-demand device which is able to form and fire one droplet at a time.

9. The lithographic apparatus according to claim 2, wherein the air condition controller device comprises an air flow device to generate a flow of air along the cooling surface of the part of the lithographic apparatus.

10. The lithographic apparatus according to claim 2, wherein the air condition controller device comprises an air dehumidifier.

11. The lithographic apparatus according to claim 1, comprising a temperature sensor configured to measure a local temperature of the cooling surface of the part of the lithographic apparatus, and a controller configured to control the droplet ejector based on an output of the temperature sensor.

12. The lithographic apparatus according to claim 9, comprising a humidity sensor configured to measure the humidity of the air flow downstream of the cooling surface of the part of the lithographic apparatus, and a controller configured to control the droplet ejector based on an output of the humidity sensor.

13. The lithographic apparatus according to claim 9, comprising a humidity sensor configured to measure the humidity of the air flow downstream of the cooling surface of the part of the lithographic apparatus, and a controller configured to control the air flow device based on an output of the humidity sensor.

14. The lithographic apparatus according to claim 1, wherein the droplet ejector is configured to form droplets with diameter between 0.1 and 100 micrometers.

15. The lithographic apparatus according to claim 1, wherein the droplet ejector is moveable with respect to the part of the lithographic apparatus.

16. The lithographic apparatus according to claim 1, wherein the cooling system is moveable with respect to the part of the lithographic apparatus.

17. The lithographic apparatus according to claim 1, wherein the cooling system is not directly in contact with the part of the lithographic apparatus.

18. The lithographic apparatus according to claim 1, wherein at least an area above the cooling surface is substantially closed off and the cooling system is arranged to operate inside the area.

19. The lithographic apparatus according to claim 1, wherein the droplet ejector includes a chamber connected to a nozzle and a reservoir and an actuation element configured to create the droplets.
